(19) United States
(12) Patent Application Publication
(10) Pub. No.: US 2007/0297506 A1
(43) Pub. Date: Dec. 27, 2007

(54) Decoder and decoding method

(76) Inventor: Taichiro Yamanaka, Tokyo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/820,392

(22) Filed: Jun. 19, 2007

(30) Foreign Application Priority Data
Jun. 22, 2006 (JP) P2006-172435

(51) Int. Cl. H04B 1/66

(52) U.S. Cl. 375/240

(57) ABSTRACT

According to one embodiment, a decoder includes: an error detecting device detecting a fact that an error is included in an encoded bitstream, the error making it impossible to predict a pixel value using a prediction mode; an error processing device replacing the prediction mode ruled in the bitstream with a prediction mode having a prediction direction most close to a reference prediction direction for a plurality of prediction modes allowing predicting the pixel value; and a prediction processing device predicting the pixel value using the prediction mode replaced by the error processing device.

### CROSS-REFERENCE TO RELATED APPLICATIONS

This application is based upon and claims the benefit of priority from Japanese Patent Application No. 2006-172435, filed Jun. 22, 2006, the entire contents of which are incorporated herein by reference.

### BACKGROUND

1. Field

One embodiment of the invention relates to a decoder and a decoding method that perform an intra-frame prediction process.

2. Description of the Related Art

In data communication, when encoded data encoding image data is sent, a receiver decodes the received encoded data by a decoder to output. When decoding the encoded data by the decoder, an error such as data change into different data, in which data “0 (zero)” changes into data “1” or data “1” changes into data “0 (zero)”, as an example, is sometimes caused due to deterioration in a radio communication state or the like. As a measure against a decoding error, an error image complement called error concealment is performed in the decoder. One example of the decoders performing the error concealment as described above is shown in Japanese Patent Application Publication (KOKAI) No. 2005-252549 (Patent document 1).

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing a decoder according to an embodiment of the invention;

FIGS. 2A to 2I are exemplary views to illustrate prediction modes to apply to a Y-component block of 4×4 size in the embodiment;

FIGS. 3A to 3I are exemplary views to illustrate prediction modes to apply to a Y-component block of 8×8 size in the embodiment;

FIGS. 4A to 4D are exemplary views to illustrate prediction modes to apply to a Y-component block of 16×16 size in the embodiment;

FIGS. 5A to 5D are exemplary views to illustrate prediction modes to apply to a U-component block or a V-component block in the embodiment;

FIG. 6 is an exemplary flowchart showing a process of an intra-frame prediction block in the embodiment;

FIG. 7 is an exemplary flowchart showing a process of an error detector in the embodiment;

FIG. 8 is an exemplary flowchart showing a process of an error processor in the embodiment;

FIG. 9 is an exemplary schematic diagram to illustrate a search of a peripheral block;

FIG. 10 is an exemplary corresponding table showing a transformation rule of prediction mode values;

FIG. 11 is an exemplary view to illustrate the transformation rule to apply to the Y-component block of 4×4 or 8×8 size in the embodiment;

FIG. 12 is an exemplary view to illustrate the transformation rule to apply to the Y-component block of 16×16 or 8×8 size in the embodiment;

FIG. 13 is an exemplary view to illustrate the transformation rule to apply to the U-component block or the V-component block in the embodiment;

FIG. 14 is an exemplary corresponding table to obtain a priority list P;

FIG. 15 is an exemplary block diagram showing a moving image reproducing apparatus including a decoder in the embodiment; and

FIG. 16 is an exemplary block diagram showing a digital television apparatus including the decoder in the embodiment.

### DETAILED DESCRIPTION

Various embodiments according to the invention will be described hereinafter with reference to the accompanying drawings. In general, according to one embodiment of the invention, a decoder includes: an error detecting device detecting a fact that an error is included in an encoded bitstream, the error making it impossible to predict a pixel value using a prediction mode; an error processing device replacing the prediction mode ruled in the bitstream with a prediction mode having a prediction direction most close to a reference prediction direction for a plurality of prediction modes allowing predicting the pixel value; and a prediction processing device predicting the pixel value using the prediction mode replaced by the error processing device.

Further, a decoding method detects a fact that an error is included in an encoded bitstream, the error making it impossible to predict a pixel value using a prediction mode; replaces the prediction mode ruled in the bitstream with a prediction mode having a prediction direction most close to a reference prediction direction for a plurality of prediction modes allowing predicting the pixel value; and predicts the pixel value using the replaced prediction mode.

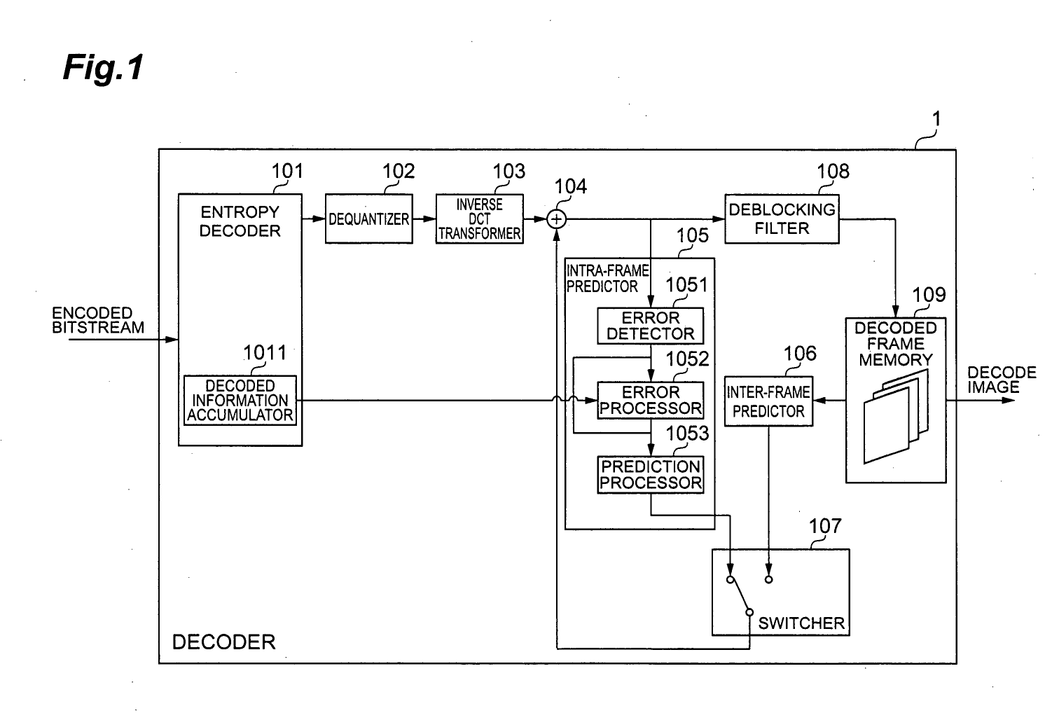

FIG. 1 is a block diagram showing a configuration of a decoder 1 according to one embodiment. The decoder 1 according to the embodiment is a H.264 decoder decoding a bitstream encoded in compliance with a H.264 standard to output a decoded frame image. The decoder 1 is composed of an entropy decoder 101, a dequantizer 102, an inverse DCT transformer 103, an adder 104, an intra-frame predictor 105, a inter-frame predictor 106, a switcher 107, a deblocking filter 108, and a decoded frame memory 109.

The entropy decoder 101 analyses a encoded bitstream inputted into the decoder 1 in accordance with a syntax (an expression rule of a data string) ruled by the H.264 standard to output a decoded data being an analysis result to the dequantizer 102. The entropy decoder 101 includes a decoded data accumulator 1011. The decoded data accumulator 1011 accumulates various types of header data extracted from the bitstream in units of frame. The data accumulated in the decoded data accumulator 1011 is outputted to the intra-frame predictor 105.

The dequantizer 102 performs a dequantizing process of the data outputted from the entropy decoder 101 to output the data after the dequantizing process to the inverse DCT transformer 103. The inverse DCT transformer 103 performs an inverse DCT (Discrete Cosibe Transform) process with respect to the data outputted from the dequantizer 102 to output the data after the inverse DCT process to the adder 104. Image data obtained from the inverse DCT process is called a residual data in general. Hereinafter, the image data outputted by the inverse DCT transformer 103 will be called the residual data.

The adder 104 arithmetically adds the residual data and the data outputted from the intra-frame predictor 105 or the inter-frame predictor 106 via the switcher 107 to output the result to the intra-frame predictor 105 and the deblocking filter 108.

The intra-frame predictor 105 is composed of an error detector 1051, an error processor 1052, and a prediction processor 1053. The intra-frame predictor 105 operates when a macroblock to be processed is found to be encoded into an intramode (intra-frame prediction mode) as a result of the analysis of the bitstream in the entropy decoder 101, and then predicts the pixel value of the block to be processed in accordance with the prediction mode using the pixel value of the peripheral pixel outputted from the adder 104 to thereby output a predicted image formed by the predicted pixel values to the switcher 107. The detail operation of the intra-frame predictor 105 will be described later.

The inter-frame predictor 106 operates when the macroblock to be processed is found to be encoded into an intermode (inter-frame prediction mode) as a result of the analysis of the bitstream in the entropy decoder 101, and then performs a motion compensation and a weighted prediction to output the predicted image to the switcher 107.

The switcher 107 is to input any one of the output of the intra-frame predictor 105 and the output of the inter-frame predictor 106 into the adder 104. The switcher 107 selects the output of the intra-frame predictor 105 when the encoded mode of the macroblock to be processed is the intramode, and selects the output of the inter-frame predictor 106 when the encoded mode of the macroblock to be processed is the intermode.

The deblocking filter 108 eliminates a block distortion from the decoded image data outputted from the adder 104. The output data of the deblocking filter 108 is the decoded image outputted by the decoder 1, and is accumulated in the decoded frame memory 109 as an option for a reference frame.

As described above, when the encoded bitstream is inputted, the decoder 1 analyzes the encoded bitstream in the entropy decoder 101. When the analysis result by the entropy decoder 101 is the intramode, the decoder 1 obtains a decoded data by the processes by the dequantizer 102, the inverse DCT transformer 103, the adder 104 and the intra-frame predictor 105, applies a filter to the decoded data by the deblocking filter 108, and accumulates the data applied the filter in the decoded frame memory 109 and at the same time outputs as a decoded image.

Meanwhile, when the analysis result by the entropy decoder 101 is the intermode, the decoder 1 obtains a decoded data by the processes by the dequantizer 102, the inverse DCT transformer 103, the adder 104 and the inter-frame predictor 106, applies a filter to the decoded data by the deblocking filter 108, and accumulates the data applied the filter in the decoded frame memory 109 and at the same time outputs as a decoded image.

(Intra-Frame Prediction Process in H.264 Standard)

Subsequently, the description will be given of the intra-frame prediction process in the H.264 standard. In the intra-frame prediction process in the H.264 standard, with respect to the block having any of the sizes 4×4, 8×8, or 16×16, prediction values of the respective pixel values of the block are determined based on the prediction mode ruled in compliance with a syntax in the bitstream. The size (4×4, 8×8, 16×16) of the block to be processed is recorded in the bitstream.

The intra-frame prediction process is executed for each of a Y-component (brightness), a U-component (color difference) and a V-component (color difference), separately. Further, as for the Y-component, the intra-frame prediction process is executed for each of the block of 4×4 size, the block of 8×8 size, and the block of 16×16 size, separately. Meanwhile, as for the U-component and the V-component, the intra-frame prediction process is executed only for the block of 8×8 size.

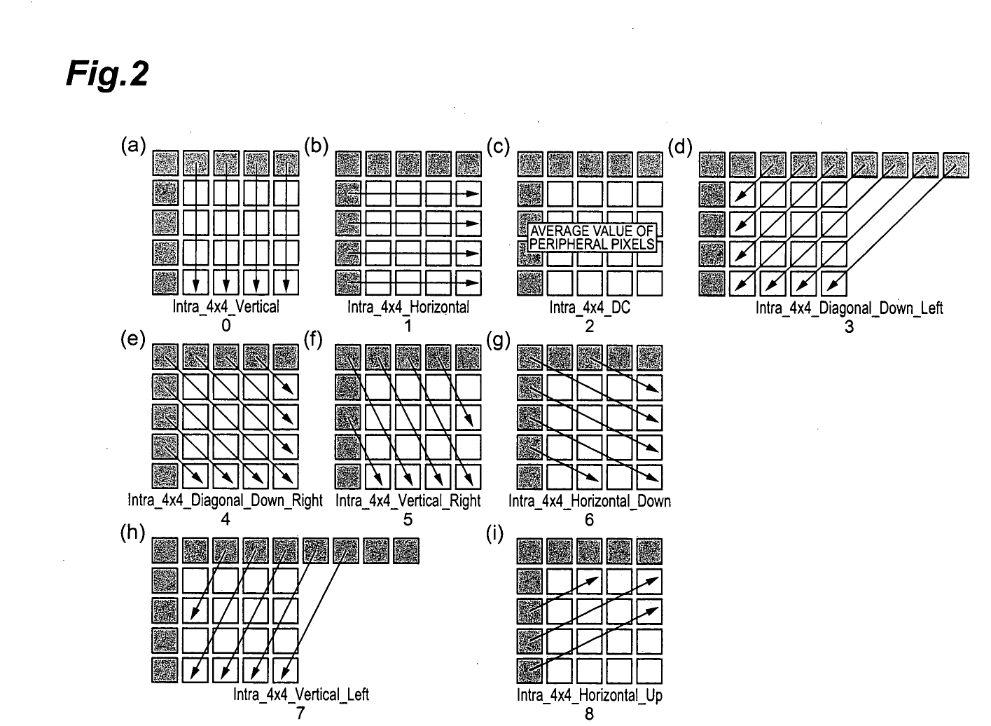

In FIGS. 2A to 2I, FIGS. 3A to 3I, FIGS. 4A to 4D and FIGS. 5A to 5D, the prediction modes defined in the H.264 standard is schematically shown. In FIG. 2 to FIG. 5, a white square indicates each pixel of the block to be processed and a gray square indicates each peripheral pixel of the block to be processed. A predictive pixel value of the block to be processed is calculated by an arithmetic expression defined for each prediction mode using the pixel values of the peripheral pixels as a parameter. The arithmetic expression defined for the each prediction mode will be described with reference to FIG. 2 to FIG. 5.

In FIGS. 2A to 2I, there are shown 9 types of prediction modes defined in the case where the block to be processed is the Y-component of 4×4 size. When the block to be processed is the Y-component of 4×4 size, any of left four points, upper four points, upper right four points and upper left one point of the block to be processed is referred. In the each prediction mode, the pixel value of the each pixel having an arrow passing therethough is replaced with the pixel value of the peripheral pixel at the start point of the arrow. Provided, however, in the prediction mode shown in FIG. 2C, the pixel value of the each pixel is replaced with an average value of the pixel values of the peripheral pixels.

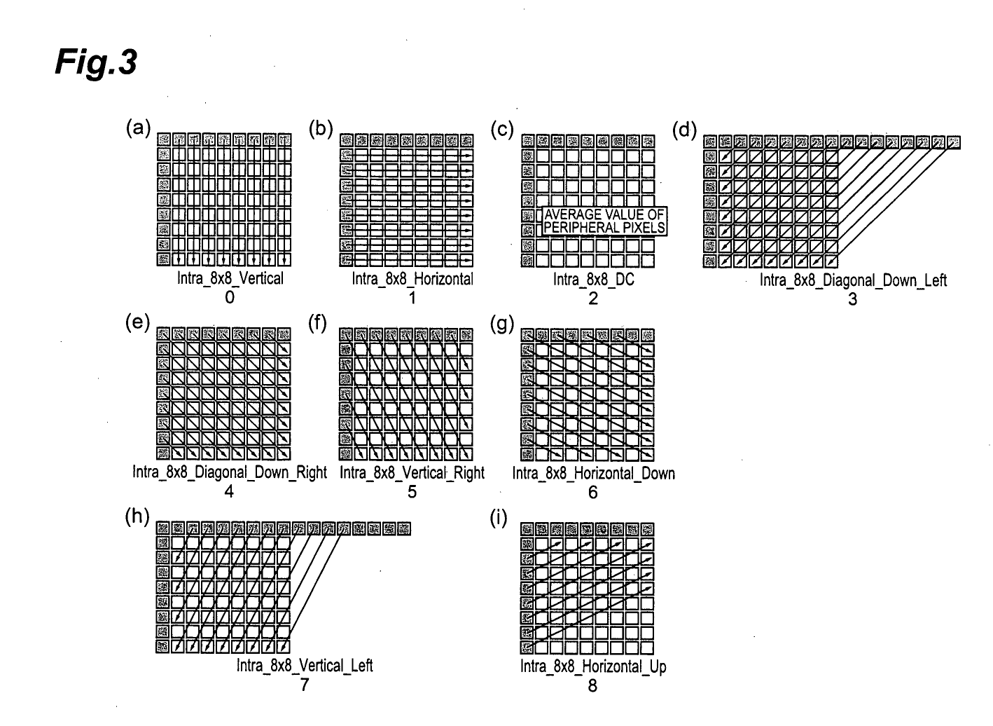

In FIGS. 3A to 3I, there are shown 9 types of prediction modes defined in the case where the block to be processed is the Y-component of 8×8 size. When the block to be processed is the Y-component of 8×8 size, any of left eight points, upper eight points, upper right eight points and upper left one point of the block to be processed is referred. In the each prediction modes, the pixel value of the each pixel having an arrow passing therethough is replaced with a value (will be described later) corresponding to the peripheral pixel at the start point of the arrow. Provided, however, in the prediction mode shown in FIG. 3C, the pixel value of the each pixel is replaced with an average value of the values corresponding to the pixel values of the peripheral pixels. Here, the above-described value corresponding to the peripheral pixel means a value calculated by a weighted average of the focused-peripheral pixel and its both adjacent peripheral pixels.

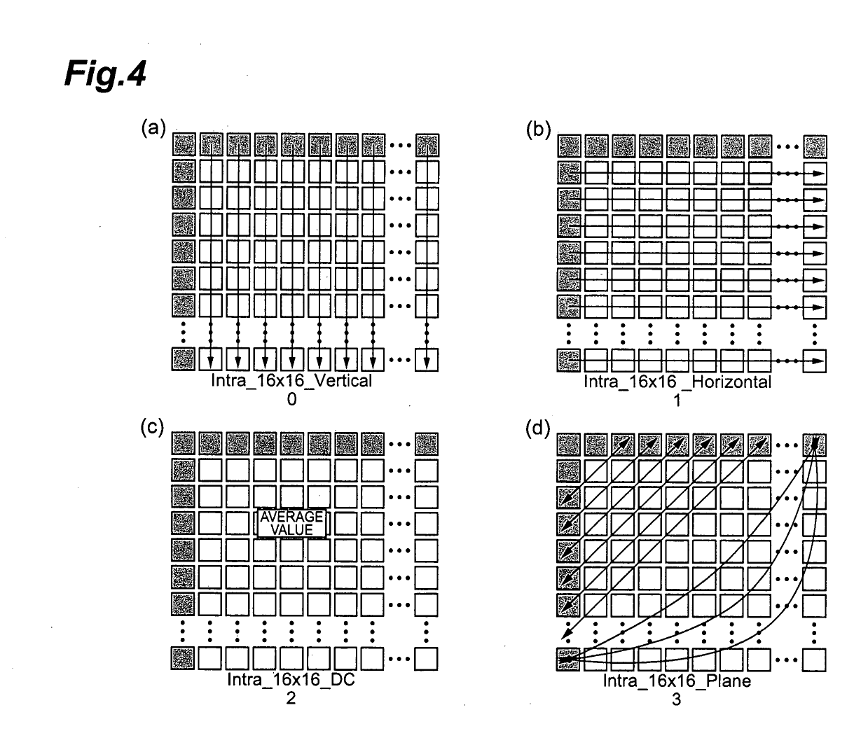

In FIGS. 4A to 4D, there are shown 4 types of prediction modes defined in the case where the block to be processed is the Y-component of 16×16 size. When the block to be processed is the Y-component of 16×16 size, any of left 16 points, upper 16 points, and upper left one point of the block to be processed is referred. In the each prediction mode, the pixel value of the each pixel having the arrow passing therethough is replaced with the pixel value of the peripheral pixel at the start point of the arrow. Provided, however, in the prediction mode shown in FIG. 4C, the pixel value of the each pixel is replaced with the average value of the pixel values of the peripheral pixels.

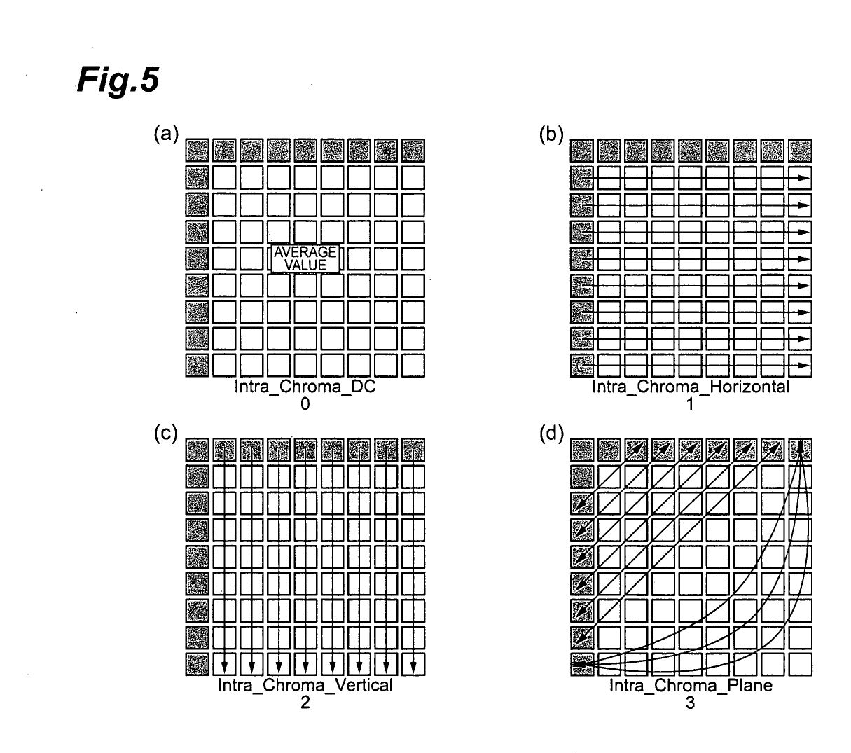

In FIGS. 5A to 5D, there are shown 4 types of prediction modes defined in the case where the block to be processed is the U-component and the V-component. When the block to be processed is the U-component or the V-component of 16×16 size, any of left 16 points, upper 16 points, and upper left one point of the block to be processed is referred. In the each prediction mode, the pixel value of the each pixel having the arrow passing therethough is replaced with the pixel value of the peripheral pixel at the start point of the arrow. Provided, however, in the prediction mode shown in FIG. 5A, the pixel value of the each pixel is replaced with the average value of the pixel values of the peripheral pixels.

As shown in FIG. 2 to FIG. 5, the peripheral pixel to be referred when calculating the predictive pixel value is different for the each prediction mode. Also, a prediction direction drawn by the arrow is different for the each prediction mode. In FIG. 2 to FIG. 5, prediction mode names and prediction mode values shown below the respective prediction modes are those defined by an encoding rule of the H.264 standard. Note that the prediction mode values defined by the encoding rule of the H.264 standard are not determined in accordance with the sequence in the prediction directions.

(Error Caused in Intra-Frame Prediction Process)

In the H.264 standard, when the peripheral pixel that has to be referred in order to perform the intra-frame prediction process satisfies any of the following conditions (1) to (5), it is determined that the intra-frame prediction process is inexecutable due to an error included in the bitstream.

(1) “There exists no macroblock including the peripheral pixel that has to be referred to perform the intra-frame prediction process.”

The condition (1) possibly arises in the case where the block to be processed in the intra-frame prediction process exists at an end of the frame. As described above, the peripheral pixel to be referred when calculating the predictive pixel value is different for the each prediction mode, and in the bitstream compliant to the H.264 standard, the prediction mode using an unreferrable peripheral pixel is in no case applied. Accordingly, when there exists no macroblock including the peripheral pixel that has to be referred to perform the intra-frame prediction process, it is determined to be the error.

(2) “There exists no macroblock including the peripheral pixel that has to be referred to perform the intra-frame prediction process in the same slice.”

Here, the slice means a group of an integer pieces of macroblock ruled under the H.264 standard and continuous in the bitstream, and various data related to the slice is encoded in the bitstream. In the H.264 standard, when the macroblock having the peripheral pixel that has to be referred does not exist in the same slice as of the macroblock to be processed, it is provided the peripheral pixel that has to be referred cannot be referred. Accordingly, when the macroblock including the peripheral pixel that has to be referred to perform the intra-frame prediction process does not exist in the same slice, it is determined to be the error. By referring to the slice data included in the bitstream, it is possible to determine whether or not the above condition (2) is satisfied.

(3) “The macroblock including the peripheral pixel that has to be referred to perform the intra-frame prediction process cannot be decoded.”

The condition (3) is possibly caused in any macroblock in any bitstream. When the macroblock including the peripheral pixel that has to be referred to perform the intra-frame prediction process cannot be decoded, the intro-frame prediction process cannot be performed. Hence, when the macroblock including the peripheral pixel that has to be referred to perform the intra-frame prediction process cannot be decoded, it is determined to be the error.

(4) “The macroblock including the peripheral pixel that has to be referred to perform the intra-frame prediction process is encoded into the intermode and the value of a constrained intra_pred_flag in a Picture parameter set RBSP syntax is “1”.”

The condition (4) is possibly caused in any macroblock in any bitstream. Note that that the value of the constrained_intra_pred_flag is “1” means that the pixel included in the macroblock encoded into the intermode is unreferable as a peripheral pixel so as to perform the intra-frame prediction process. Meanwhile, that the value of the constrained_intra_pred_flag is “0 (zero)” means that the pixel included in the macroblock encoded into the intermode is referrable as a peripheral pixel so as to perform the intra-frame prediction process.

(5) “The sum of the predictive pixel value of the block including the peripheral pixel desired to refer and a residual is not calculated.”

In the intra-frame prediction process of the H.264 standard, it is provided that a plurality of blocks included in the same macroblock be processed in the order of a zigzag scan. In the macroblock to be subject to the intra-frame prediction process in units of a block of 4×4 size, for example, the block of 4×4 size in the upper right of the block of 4×4 size to be processed fourth in the same macroblock is unprocessed, in which the upper right peripheral pixels included in the block are not calculated, so that the error of the condition (5) is possibly caused.

In order to perform the intra-frame prediction process, it is necessary that the pixel that has to be referred in the specific prediction mode provided in the bitstream be practically referable. Accordingly, in the embodiment, when performing the intra-frame prediction with respect to the block to be processed, the above-described conditions (1) to (5) are verified for each pixel that has to be referred in the specific prediction mode. For each pixel that has to be referred depending on the prediction mode, when all the above-described conditions (1) to (5) are not satisfied, the intra-frame prediction process using the prediction mode is performed. Meanwhile, for any pixel that has to be referred depending on the prediction mode, when any of the above-described conditions (1) to (5) is satisfied, the intra-frame prediction process using the prediction mode is not performed.

In the mean time, when the error of the condition (1) or (5) is determined, an error is caused in such data portion in the bitstream that corresponds to the prediction mode. Specifically, by counting the number of macroblocks from the top of the frame in the betstream, the positions of the macroblocks in the frame can be recognized, and further, by counting the number of blocks from the top of the macroblock in the bitstream, the positions of the blocks in the macroblock can be recognized. Thus, the positions of the blocks can be recognized by counting the number of blocks in the bitstream, so that the error is in no case caused. Accordingly, as for the error of the condition (1) or (5), only the data portion corresponding to the prediction mode is an error cause, therefore, when the error of condition (1) or (5) is determined, it is found that the error is caused in such data portion in the bitstream that corresponds to the prediction mode. Meanwhile, when the error of condition (2), (3) or (4) is determined, the error is not always caused in such data portion in the bitstream that corresponds to the prediction mode, and may be caused in the other data portion.

(Error Detection Process and Error Concealment Process in the Embodiment)

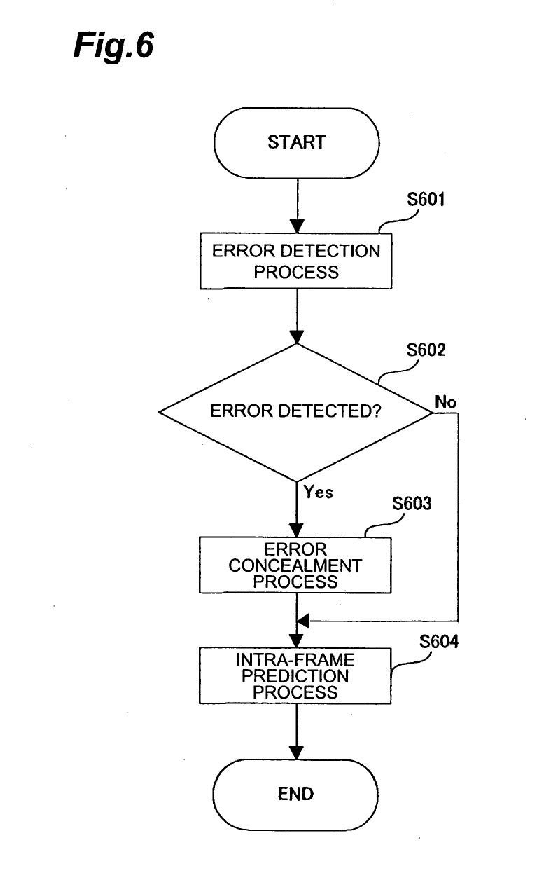

Hereinafter, the description will be given of the operation of the intra-frame predictor 105. First, an outline of the operation of the intra-frame predictor 105 will be described with reference to the flowchart in FIG. 6.

The intra-frame predictor 105 performs an error detection process by the error detector 1051 to detect presence or absence of the error of the above-described conditions (1) to (5) together with the error type (S601). When the error is detected, the intra-frame predictor 105 performs the error concealment process in accordance with the error type by the error processor 1052, and performs the intra-frame prediction process compliant with the H.264 standard by the prediction processor 1053 thereafter (S602, S603, S604). Meanwhile, when the error is not detected, the intra-frame predictor 105 performs the intra-frame prediction process compliant with the H.264 standard by the prediction processor 1053 without performing the error concealment process (S602, S604).

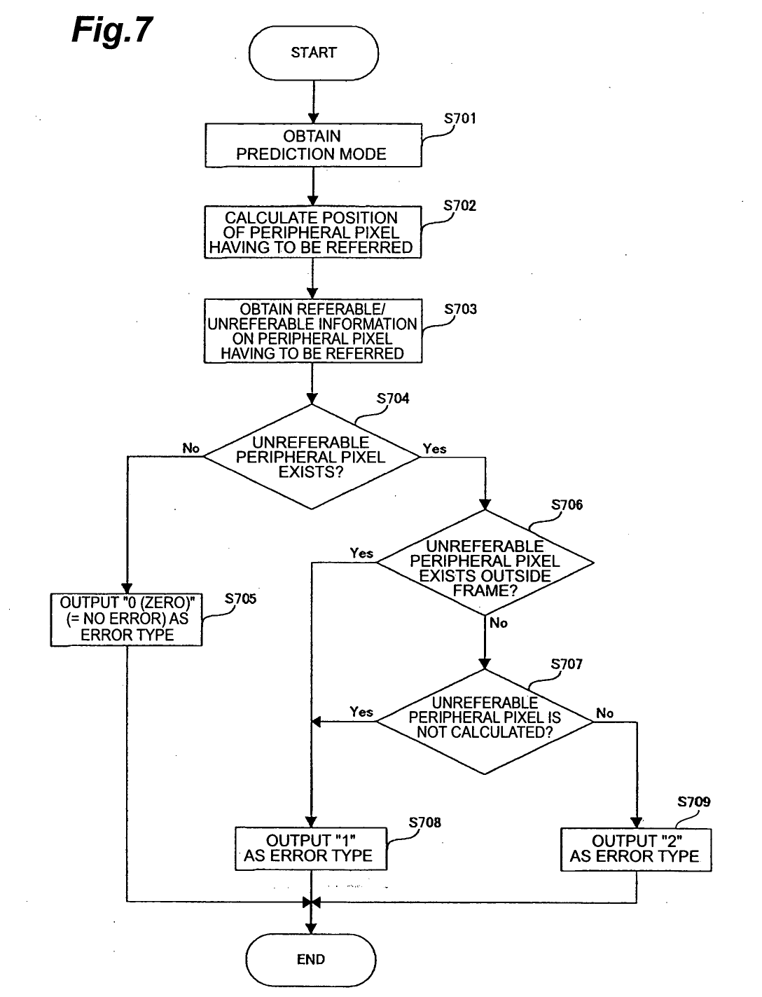

Subsequently, detail operations of the error detector 1051 will be described with reference to the flowchart in FIG. 7.

The error detector 1051 obtains data outputted from the entropy decoder 101 and specifying the prediction mode of the block to be processed in the current intra-frame prediction process (S701), and calculates the position of the peripheral pixel that has to be referred in the prediction mode (S702). After that, the error detector 1051 obtains data outputted from the entropy decoder 101 and to determine whether it is referable or unreferrable, for all the peripheral pixels of which positions are calculated in S702. Here, the data to determine whether it is referable or unreferable includes, at least, the items shown below.

(1) Whether the peripheral pixel exists in the frame (corresponds to 1) or not (corresponds to 0 (zero)).

(2) Whether the peripheral pixel exists in the same slice (corresponds to 1) or not (corresponds to 0 (zero)).

(3) Whether the error is caused when the peripheral pixel is decoded (corresponds to 1) or not (corresponds to 0 (zero)).

(4) Whether the peripheral pixel is encoded into the intermode and, at the same time, the condition that the value of the constrained_intra_pred_flag be “1” is true (corresponds to “1”) or not (corresponds to 0 (zero)).

(5) Whether the intra-frame prediction process is completed to be executed to the block including the peripheral pixel (corresponds to “1”) or not (corresponds to 0 (zero)).

Note that, as described above, for any of the items (1) to (5), it is encoded into “1” when it is “true” and “0 (zero)” when it is “false”.

Subsequently, the error detector 1051 determines whether or not the unreferrable peripheral pixel exists or not among the peripheral pixels at the positions calculated in S702 using the information on the above-described items (1) to (5). Specifically, the error detector 1051 determines either the above-described items are “1” or “0 (zero)”, respectively, for each peripheral pixel at the positions calculated in S702. Here, when all the items (1) to (5) are “1” for the respective peripheral pixels at the positions calculated in S702, the error detector 1051 determines to be no error and goes to S705 to output 0 (zero) as a value of the error type. Meanwhile, when any of the items (1) to (5) is 0 (zero) for any of the peripheral pixels at the positions calculated in S702, the error detector 1051 determines to be the error and goes to the processes in and after S706 to determine the error type.

In S706, the error detector 1051 determines either the unreferrable peripheral pixel due the error caused is inside the frame or outside the frame (S706). Here, when it is determined that the peripheral pixel having the error caused is outside the frame, namely, the value of the above item (1) is determined to be “0 (zero)”, the error detector 1051 outputs “1” as a value of the error type (S708). Meanwhile, when it is determined that the peripheral pixel having the error caused is inside the frame, namely, the value of the above item (1) is determined to be “1”, then the process goes to S707.

In S707, the error detector 1051 determines whether the unreferrable peripheral pixel due the error caused is calculated or not (S707). Here, when it is determined that the peripheral pixel is not calculated, namely, when the value of the above item (5) is determined to be “0 (zero)”, the error detector 1051 outputs “1” as a value of the error type (S708). Meanwhile, when it is determined that the peripheral pixel is calculated, namely, when the value of the above item (5) is determined to be “0 (zero)”, the error detector 1051 outputs “2” as a value of the error type (S709). The error type value “2” means that any of the above items (2) to (4) is “0 (zero)” for the peripheral pixel having the error caused.

As can be understood by the above-described description, the error type is data to identify whether or not such the data portion in the bitstream that is referred when determining the error is only the prediction mode for the block to be processed. When the error type is “0 (zero)”, no error exists. When the error type is “1”, the error of the item (1) or (5) exists, and such the data portion in the bitstream that is referred when determining the error is only the prediction mode for the block to be processed. Further, when the error type is “2”, the error of the item (2), (3) or (4) exists, and such the data portion in the bitstream that is referred when determining the error exists in and other than the prediction mode for the block to be processed.

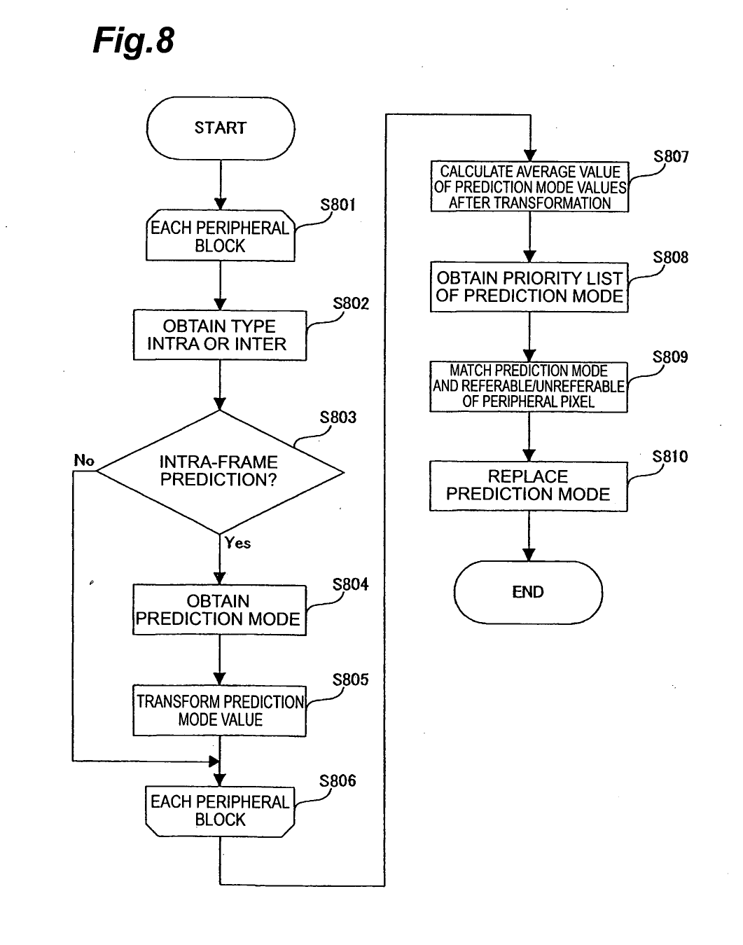

Subsequently, detail operations of the error processor 1052 will be described with reference to the flowchart in FIG. 8. FIG. 8 is a flowchart showing a detail process of the error processor 1052. When the value of the error type outputted by the error detector 1051 is “1”, it is possible to identify such the data portion in the bitstream that has the error caused is the prediction mode for the block to be processed. In this case, the error processor 1052 performs the error concealment process in accordance with the flow in FIG. 8.

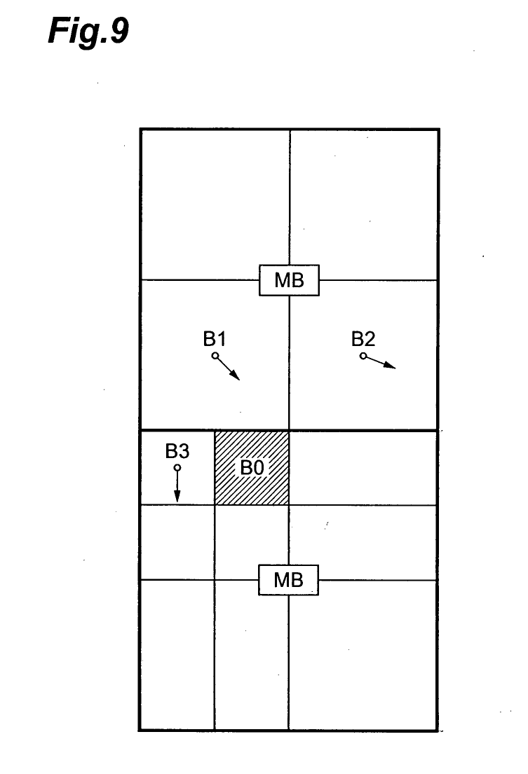

First, the error processor 1052 seeks for such peripheral blocks that are at the left, above, upper right and upper left with respect to the block to be processed and adjacent thereto, out of the peripheral blocks adjacent to the block to be processed. The error processor 1052, then, performs the processes of S802 to S805 to these peripheral blocks. Here, the peripheral blocks at the left, above, upper right and upper left of the block to be processed and adjacent thereto are different in number depending on the block to be processed and the size of the peripheral block. For instance, as shown in FIG. 9, in the case where a block B0 (zero) to be processed is of 4×4 size and has a single piece of a peripheral block B1 of 8×8 size adjacent thereto at the upper left and thereabove, another peripheral block B2 of 8×8 size adjacent thereto at the upper right thereof, and a single piece of peripheral block B3 of 4×4 size adjacent thereto at the left; the number of the peripheral blocks is three. Note that, in FIG. 9, the arrows shown in the blocks B1 to B3 indicate the prediction directions of the respective blocks.

In S802, the error processor 1052 refers to data related to the peripheral blocks sought to determine the respective peripheral blocks are encoded into either the intermode or the intramode (S802). Subsequently, in S803, as to the peripheral block currently processed, the error processor 1052 determines whether or not it is encoded into the intromode, using the data specifying the encoding mode obtained in S802. Here, when the peripheral block is encoded into the intramode, the process by the error processor 1052 goes to S804. Meanwhile, when the peripheral block is not encoded into the intramode, the process by the error processor 1052 goes to S806.

In S804, the error processor 1052 obtains a prediction mode value x of the peripheral block encoded into the intramode (S804). Note that the prediction mode value x of the peripheral block is outputted from the entropy decoder 101, therefore, what the error processor 1052 to do is just to import the output of the entropy decoder 101.

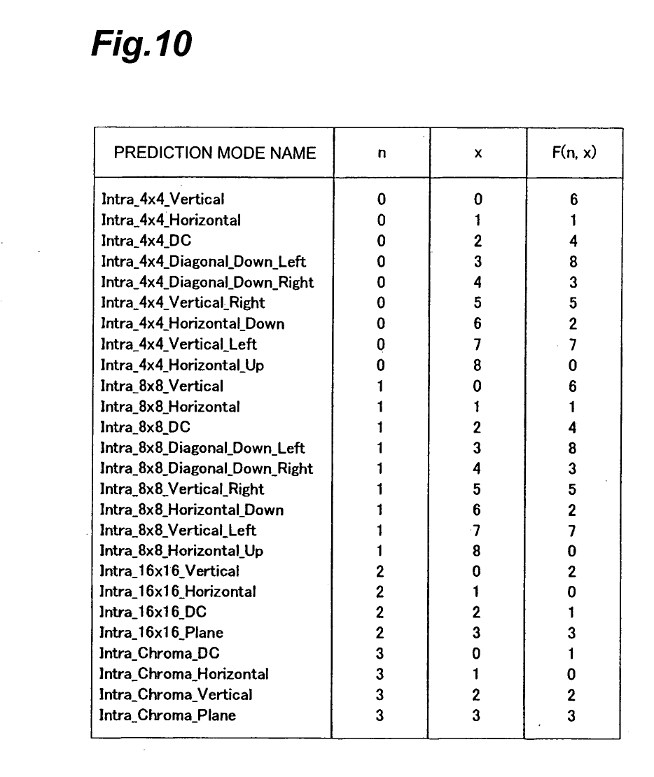

Subsequently, in S805, the error processor 1052 transforms the prediction mode value x using a mapping F defined as shown in FIG. 10 to obtain a transformed prediction mode value F (n, x) (S805). In a corresponding table in FIG. 10, a parameter n shows the type (Y, U, V) of the components of the peripheral block, and particularly in the case of the Y-component, it shows the block size. Specifically, “0 (zero)” is assigned to the Y-component of 4×4 size, “1” is assigned to the Y-component of 8×8 size, “2” is assigned to the Y-component of 16×16 size, and “3” is assigned to the U-component and the V-component.

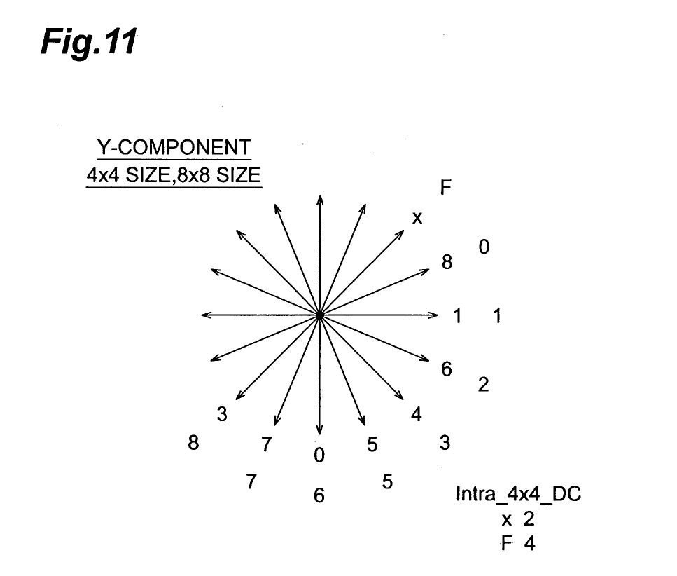

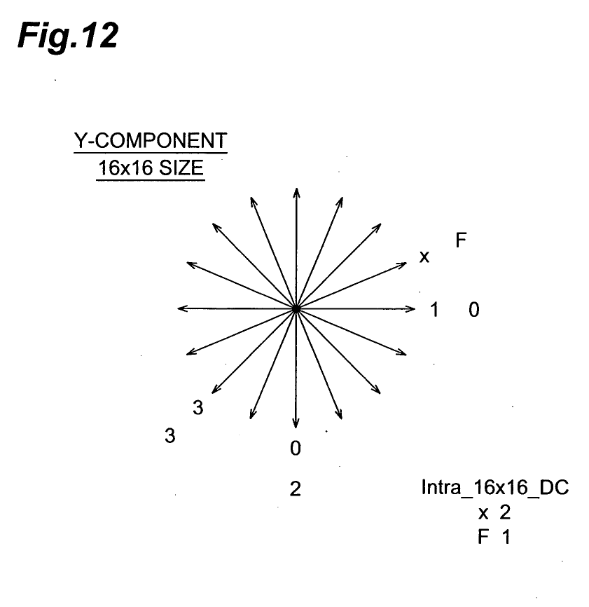

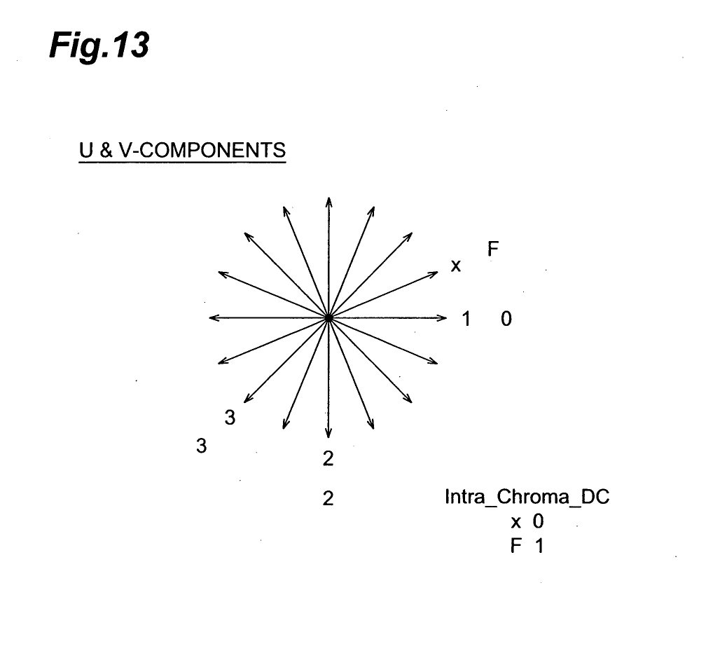

The mapping F (n, x) has a characteristic of sorting the prediction mode values x indicated in compliance with the syntax (encording rule) of the H.264 standard clockwise in accordance with the prediction directions of the respective prediction modes shown in FIG. 2 to FIG. 5. In FIG. 11, a correspondence between the prediction mode value x before transformation and the prediction mode value F after transformation in the case where the peripheral block is the Y-component of 4×4 size or 8×8 size is shown together with the prediction directions. Further, in FIG. 12, a correspondence between the prediction mode value x before transformation and the prediction mode value F after transformation in the case where the peripheral block is the Y-component of 16×16 size is shown together with the prediction directions. Further, in FIG. 13, a correspondence between the prediction mode value x before transformation and the prediction mode value F after transformation in the case where the peripheral block is the U-component or the V-component is shown together with the prediction directions. In FIG. 11 to FIG. 13, the arrows radiating outward show the prediction directions corresponding to the prediction modes, respectively. The figures shown outward of the arrows are the prediction mode values x, F corresponding to the prediction directions of the arrows, respectively. The prediction mode value x before transformation is assigned without regard to the prediction direction, however, the prediction mode value F after transformation is assigned in accordance with the order of the prediction directions. Specifically, the prediction mode value F after transformation is set to increase as it goes clockwise. Note that, for Intra_{—}4×4_DC Intra_{—}8×8_DC, Intra_{—}16×16_DC and Intra_Chroma_DC, which average the pixel values of the peripheral pixels, a numerical value around the middle is assigned in a corresponding manner, as a prediction mode value F after transformation.

Subsequently, in S803, when it is determined that the peripheral block is not encoded into the intramode or when the transformation process of the prediction mode value ends in S805, and when there is an unprocessed peripheral block, then the process goes back to S802 to process the peripheral block (S806). Meanwhile, all the peripheral blocks are processed, then the process goes to S807.

In S807, the error processor 1052 calculates an average value Avg of the prediction mode values F after transformation based on the prediction mode values F (n. x) after transformation of the peripheral blocks. When the number of the peripheral blocks encoded into the intramode is defined as “m” and the prediction mode values before transformation of the peripheral blocks are defined as “x_i (i=1, 1, 2, . . . , m-1)”, the average value Avg can be calculated by an equation (1) below.

$$Avg = \frac{{\sum }_{i = 0}^{m - 1} F ( n , x\_i )}{m} \\ ( Avg is an integer arithmetic herein . ) \qquad [ Equation 1 ]$$

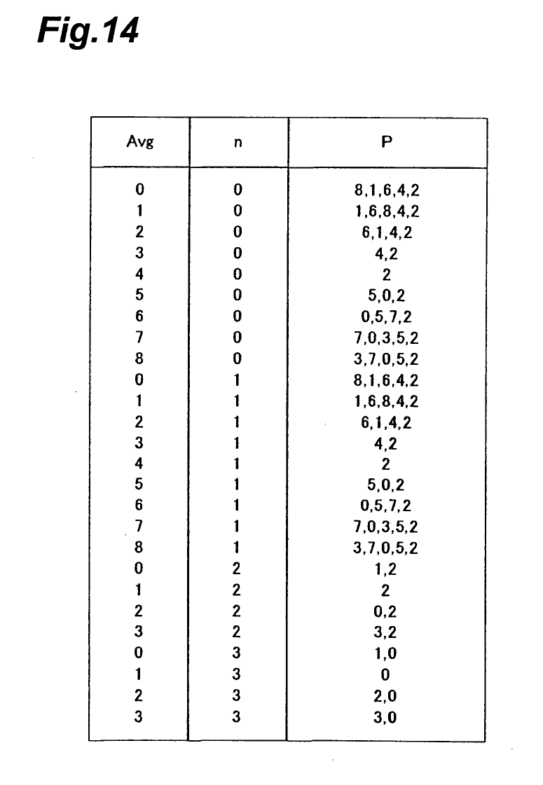

Subsequently, in S808, the error processor 1052 acquires priority lists P of the prediction mode values x defined as shown in FIG. 14, which correspond to the average values Avg of the prediction mode values after transformation and the parameters n (S808). The priority lists P of the prediction mode values x shown in FIG. 14 are permutations composed of prediction mode values x indicated in compliance with the syntax of the H.264 standard, as elements. For each combination of the average value Avg of the prediction mode values F after transformation and the parameter n, a group of priority list P composed of a plurality of prediction mode values x, as elements, is assigned in a corresponding manner. The prediction mode included in the priority list P and corresponding to the each prediction mode value x is a prediction mode option to be applied in stead of the prediction mode of the block to be processed. In the priority lists P, the prediction mode value x at the top has the highest priority, and the priority lowers as it goes downward. In the priority list P, out of the prediction modes as shown in FIG. 11 to FIG. 13, the prediction mode value x corresponds to the average value Avg of the prediction mode values after transformation has the highest priority, showing a characteristic that as the prediction direction of the prediction mode is close, the priority is high. Note that, as for Intra_{—}4×4_DC, Intra_{—}8×8_DC Intra_{—}16×16_DC, and Intra_Chroma_DC, which are the prediction modes applicable even when all the peripheral pixels are unreferreble, therefore, the respective DC modes compose the last elements of the respective permutations.

Subsequently, the error processor 1052 selects one prediction mode value x having the highest priority possible and executable, based on the priority list P of the prediction mode and the data as to the peripheral pixels indicating referable or unreferable and outputted from the entropy decoder 101 (S809). Specifically, the error processor 1052 focuses on the plurality of prediction modes included in the priority lists P one by one from the highest priority to determine the above items (1) to (5) with respect to the plurality of peripheral pixels that have to be referred so as to perform the focused prediction mode, and selects the prediction mode when there is no unreferable peripheral pixel. In this manner, out of the prediction modes of which pixel values are predictable, that having the closest prediction direction to the prediction direction corresponding to the average value Avg of the prediction mode values is selected. The error processor 1052, then, replaces the prediction mode set to the block to be processed with the selected prediction mode (S810).

The prediction processor 1053 performs the intra-frame prediction process compliant to the H.264 standard using the replaced prediction mode, when the prediction mode was replaced by the error processor 1052. The intra-frame prediction process using the prediction mode is the same as described with reference to FIG. 2 to FIG. 5.

As has been described, when the error type value outputted from the error detector 1051 is “1”, there exists an error in such data portion in the bitstream that corresponds to the prediction mode, therefore the error processor 1052 replaces the prediction mode of the block to be processed by referring to the prediction modes of the peripheral blocks to thereby perform the error concealment, and the prediction processor 1053 performs the intra-frame prediction process in accordance with the replaced prediction mode. With this, when the error is caused in the macroblock encoded into the intramode, the decoder 1 performs the error concealment process using the data of the same frame, so that the error concealment process can be performed highly speedy, as compared to the case where the error concealment process is performed using the data of the other frame. Further, as to the prediction mode, although it also depends on the characteristic of an algorithm when encoding the bitstream, however, its correlation with the peripheral block in the same frame tends to increase in general, so that the decoder 1 performs the error concealment process using the data of the same frame and that an image having a favorable image quality can obtained.

Meanwhile, when the error type value outputted from the error detector 1051 is “2”, the error does not always exist in such data portion in the bitstream that corresponds to the prediction mode, therefore, even when the error concealment replacing the prediction mode of the block to be processed is performed, the favorable image quality cannot always be obtained. Accordingly, then, what the prediction processor 1053 to do is, just to perform the error concealment by applying the other method shown in Japanese Patent Application Publication (KOKAI) No. 2005-252549. Note that the prediction processor 1053 may also perform the intra-frame prediction process compliant to the H.264 standard using the above-described prediction mode replaced in the error concealment process according to the above-described embodiment.

Note that, as in the error concealment process according to the above-described embodiment, it is preferable that the priority list P is obtained on the basis of the prediction directions corresponding to the average values Avg of the prediction mode values F of the adjacent blocks. The prediction mode values F of the adjacent blocks are close to the original prediction mode value of the block to be processed, and further, the average value Avg of the prediction mode values F of the adjacent blocks has a low possibility in deviating from the original prediction mode value F of the block to be processed. Note that, in the error concealment process according to another embodiment, the priority list P may be obtained on the basis of the prediction direction of one block adjacent to the block to be processed. Further, in the error concealment process according to still another embodiment, the priority list P may be obtained on the basis of the prediction direction of the block to be processed. Further, in the error concealment process according to still another embodiment, the priority list P may be obtained on the basis of the prediction direction corresponding to a mid-value of the prediction mode values F of the adjacent blocks.

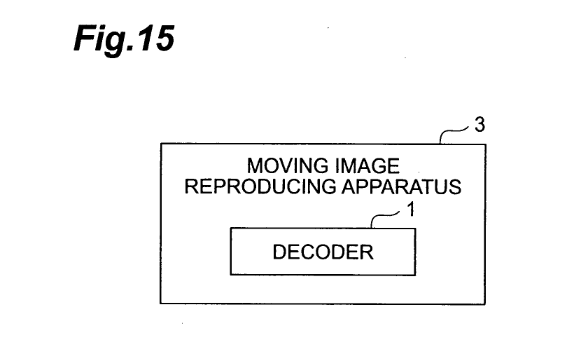

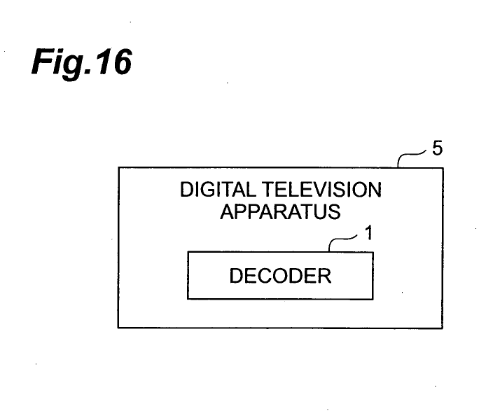

As shown in FIG. 15, the decoder according to the above-described embodiment can be used in a moving image reproducing apparatus in compliance with the H.264 standard. As a moving image reproducing apparatus in compliance with the H.264 standard, there are a moving image reproducing apparatus in compliance with a HD DVD (High Definition Digital Versatile Disc) standard, a moving image reproducing apparatus in compliance with Blu-day Disc standard, and so forth, as examples. Furthermore, as shown in FIG. 16, the decoder according to the above-described embodiment can be used in a digital television apparatus receiving a digital broadcasting to display the broadcasted content on a screen.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A decoder comprising:
an error detecting device configured to detect that an error is included in an encoded bitstream, the error making it impossible to predict a pixel value using a first prediction mode;
an error processing device configured to replace the first prediction mode ruled in the bitstream with a second prediction mode having a prediction direction closest to a reference prediction direction for a plurality of prediction modes allowing for prediction of the pixel value; and
a prediction processing device configured to predict the pixel value using the second prediction mode.

2. The decoder according to claim 1,
wherein the reference prediction direction comprises an average direction of the prediction directions corresponding to prediction modes of a plurality of blocks adjacent to a block having the error detected by said error detecting device.

3. The decoder according to claim 1,
wherein the reference prediction direction comprises the prediction direction corresponding to a prediction mode of a block adjacent to a block having the error detected by said error detecting device.

4. The decoder according to claim 1,
wherein the reference prediction direction comprises the prediction direction corresponding to a prediction mode of a block having the error detected by said error detecting device.

5. The decoder according to claim 2,
wherein, as the block adjacent to the block having the error detected by said error detecting device, the block to be subject to an intra-frame prediction process is selected.

6. The decoder according to claim 2,
wherein said error processing device is configured to perform, with respect to prediction modes of the plurality of the adjacent blocks, a process of transforming from a prediction mode value in accordance with an encoding rule into the prediction mode value in accordance with an order of the prediction directions to thereby obtain the average direction of the prediction directions by averaging the prediction mode values after transformation.

7. The decoder according to claim 1,
wherein said error processing device includes data having a plurality of prediction mode options prepared, the options being made to correspond to the reference prediction direction and having a higher priority as their prediction directions are closer to the reference prediction direction,
wherein the second prediction mode allows for prediction of the pixel value and has a highest priority out of the plurality of prediction mode options.

8. The decoder according to claim 7,
wherein the second prediction mode is configured to predict the pixel value by averaging the pixel values of the peripheral pixels of the block is given a lowest priority.

9. The decoder according to claim 1,
wherein in a case of satisfying a condition: a pixel having to be referred in the prediction mode is unreferable, said error detecting device is configured to detect a fact of including an error not allowing predicting the pixel value using the first prediction mode.

10. The decoder according to claim 9,
wherein the unreferable condition is: a macroblock including the pixel having to be referred using the first prediction mode is not in a same frame.

11. The decoder according to claim 9,
wherein the unreferable condition is: a sum of the predictive pixel value and a residual is not calculated for a block including the pixel having to be referred using the first prediction mode encoded in the bitstream.

12. A moving image reproducing apparatus including a decoder described in claim 1.

13. A digital television apparatus including a decoder described in claim 1.

14. A decoding method, comprising:
detecting that an error is included in an encoded bitstream, the error making it impossible to predict a pixel value using a first prediction mode;
replacing the first prediction mode ruled in the bitstream with a second prediction mode having a prediction direction closest to a reference prediction direction for a plurality of prediction modes allowing predicting the pixel value; and
predicting the pixel value using the second prediction mode.
